(19) United States
(12) Patent Application Publication
(10) Pub. No.: US 2009/0251054 A1
(43) Pub. Date: Oct. 8, 2009

(54) COLLECTOR AND ELECTRON TUBE

(76) Inventor: AKIRA CHIBA, Kanagawa (JP)

Correspondence Address: NEC CORPORATION OF AMERICA, 6535 N. STATE HWY 161, IRVING, TX, 75039, US

(21) Appl. No.: 12/404,452

(22) Filed: Mar. 16, 2009

(30) Foreign Application Priority Data
Apr. 3, 2008 (JP) 2008-097121

(51) Int. Cl. H01J 25/34

(52) U.S. Cl. 315/3.5

(57) ABSTRACT

A collector of an electron tube is formed by using a molybdenum-copper composite material or a tungsten-copper composite material.

This application is based upon and claims the benefit of priority from Japanese patent application No. 2008-097121, filed on Apr. 3, 2008, the disclosure of which is incorporated herein in its entirety by reference.

### TECHNICAL FIELD

The present invention relates to a collector that captures the beam of electrons emitted from an electron gun and an electron tube comprising the same.

### BACKGROUND ART

A Traveling Wave Tube (TWT) or a klystron is an electron tube used for amplifying or oscillating a RF signal through interaction between a beam of electrons emitted from an electron gun and a high-frequency circuit.

Referring to FIG. 1, a TWT 1 comprises electron gun 10 for emitting electrons, helix 20 functioning as a high-frequency circuit that allows electron beam 50 from electron gun 10 to interact with a RF signal (i.e., a microwave signal), collector 30 for collecting electron beam 50 passed through helix 20, and anode 40 for drawing out electron beam 50 from electron gun 10 as well as guiding electron beam 50 emitted from electron gun 10 into helix 20. Electron gun 10 has cathode 11 for emitting thermionic electron and heater 12 for supplying thermal energy for causing emission of the thermionic electrons.

Electron beam 50 emitted from electron gun 10 is accelerated by the electric potential difference between cathode 11 and anode 40, and guided into helix 20, and then travels inside helix 20 while interacting with the RF signal inputted through one end of helix 20. After electron beam 50 has passed through helix 20, collector 30 captures electron beam 50. Here, the RF signal, amplified through interaction with electron beam 50, is outputted through the other end of helix 20.

Power supply apparatus 60 supplies a helix voltage Eₕₑₗ, which is a negative DC voltage based on the potential (HELIX) of helix 20, to cathode 11. In addition, power supply apparatus 60 supplies a collector voltage E_{col}, which is a positive DC voltage based on the potential H/K of cathode 11, to collector 30, and supplies a heater voltage Eₕ, which is a negative DC current based on the potential H/K of cathode 11, to heater 12. In general, helix 20 is connected to a case of TWT 1 and is thereby grounded.

While FIG. 1 illustrates an example construction of TWT 1 having one collector 30, TWT 1 may have multistage collectors 30. Although FIG. 1 illustrates a construction in which anode 40 and helix 20 are connected inside power supply apparatus 60, it can be constructed such that anode 40 is supplied with an anode voltage Ea, which is a positive voltage with respect to the potential H/K of cathode 11.

FIGS. 2 and 3 show configurations of collector 30 shown in FIG. 1. Collector 30 shown in FIGS. 2 and 3 is described, for example, in Description of the Related Art in Japanese Patent Laid-Open No. 11-67108.

FIG. 2 is a sectional view showing an exemplary configuration of a collector.

FIG. 3 is a sectional view showing another exemplary configuration of the collector.

FIG. 2 shows a typical configuration with single collector of TWT, while FIG. 3 shows a typical configuration with two stage collectors of TWT.

Collector 30 shown in FIG. 2 is in a bottomed cylindrical shape in which a side wall of the cylinder is narrowed at some point toward an opening end so as to have a taper shape. Collector 30 is supported and fixed in outer shell 33 of TWT 1 by insulating ceramics 32 so that the opening faces electron gun 10 (see FIG. 1). Lead wire 34 is connected to a bottom portion of collector 30 and is drawn out through collector terminal 35 that is provided to outer shell 33.

On the other hand, as shown in FIG. 3, first collector 30₁ and second collector 30₂ are arranged in a sequence such that first collector 30₁ is closer to helix 20 (see FIG. 1) in the TWT including two stage collectors. First collector 30₁ is in a bottomless cylindrical shape, in which a side wall of the cylinder is narrowed at some point toward an opening end so as to have a taper shape. Second collector 30₂ is in a similar shape to collector 30 shown in FIG. 2.

First and second collector 30₁ and 30₂ are supported and fixed in outer shell 33 of TWT 1 by insulating ceramics 32 so that the respective openings face electron gun 10 (see FIG. 1). First lead wire 34₁ is connected to first collector 30, and drawn out through a gap provided on insulating ceramic 32 and first collector terminal 35₁ provided on outer shell 33. Second lead wire 34₂ is connected to second collector 30₂ and drawn out through second collector terminal 35₂ provided on outer shell 33.

Molybdenum (Mo), copper (Cu) or the like is generally used for collector 30 shown in FIG. 2, first collector 30, and second collector 30₂ shown in FIG. 3, which is processed in the shape shown in FIG. 2 or FIG. 3 by machining a plate or a bar made thereof.

The electron beam leaving the helix contains power that is delivered to the collector. Some of this power is converted to heat by electrons striking the collector.

If electron beam concentrates at the arbitrary point, it is difficult to melt the collector that is made of molybdenum. This is because molybdenum has a high melting point (about 2622° C.).

However, there is a problem in which it will be difficult for heat that is generated the collector to be radiated because molybdenum has comparatively small thermal conductivity (about 138 W/m·k). Accordingly, even though molybdenum is used, there is a limit to the high output power of the TWT because the temperature of the collector will significantly increases.

Additionally, molybdenum has a high melting point as described above, and a sintering material that made from powder. Because of this, gas may be enclosed in small porosity generated at the time of sintering. In the case, there is a problem in which the gas enclosed in the porosity is desorbed and the degree of vacuum in the outer shell worsens if the TWT is made by using the molybdenum collector.

On the other hand, if the collector is made of copper, heat generated at the collector is easily radiated. This is because copper has large thermal conductivity (about 398 W/m·k).

However, copper has a lower melting point (about 1083° C.) than molybdenum. If electron beam concentrate at the arbitrary point as described above, there is a possibility of melting the point. Because of this, if copper is used for the collector, it will be difficult to realize a TWT that has high output power. Additionally, in order to obtain the required output power from the TWT, a configuration in which copper is used for the collector cannot be employed if the TWT is downsized. This is because, for example, the collector needs to be formed having a certain thickness.

### SUMMARY

An object of the present invention is to provide a collector that facilitates further downsizing of an electron tube and that enables an electron tube to deliver high output power, and an electron tube comprising the same.

In order to achieve the object, a collector of the present invention is used as the collector of an electron tube,

wherein the collector is made of a molybdenum-copper composite material.

Another collector of the present invention is used as the collector of an electron tube,

wherein the collector is made of a tungsten-copper composite material.

An electron tube of the present invention comprises the collector.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a block diagram showing an exemplary configuration of a high frequency circuit system including an electron tube and a power supply apparatus;

FIG. 2 is a sectional view showing an exemplary configuration of a collector;

FIG. 3 is a sectional view showing another exemplary configuration of the collector;

FIG. 4 is a perspective view showing an exemplary configuration of a collector of the present invention; and

FIG. 5 is an A-A′ line sectional view of the collector shown in FIG. 4.

### EXEMPLARY EMBODIMENTS

The present invention will be described more fully hereinafter with reference to the accompanying drawings, in which preferred embodiments thereof are shown.

Hereinafter, the present invention will be described using a collector of a TWT as an example, whereas the present invention may be applied to a collector of a different kind of electron tube.

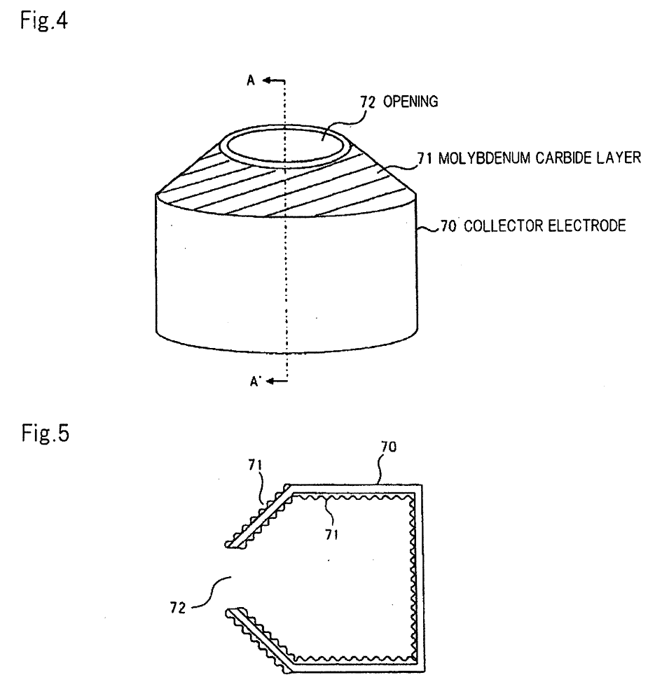

FIG. 4 is a perspective view showing an exemplary configuration of a collector of the present invention. FIG. 5 is an A-A′ line sectional view of the collector shown in FIG. 4.

Collector 70 of an exemplary embodiment is formed using a molybdenum-copper composite material.

In the exemplary embodiment, molybdenum carbide layer 71 is further formed close to a surface of the required area in collector 70 that is made of the molybdenum-copper composite material.

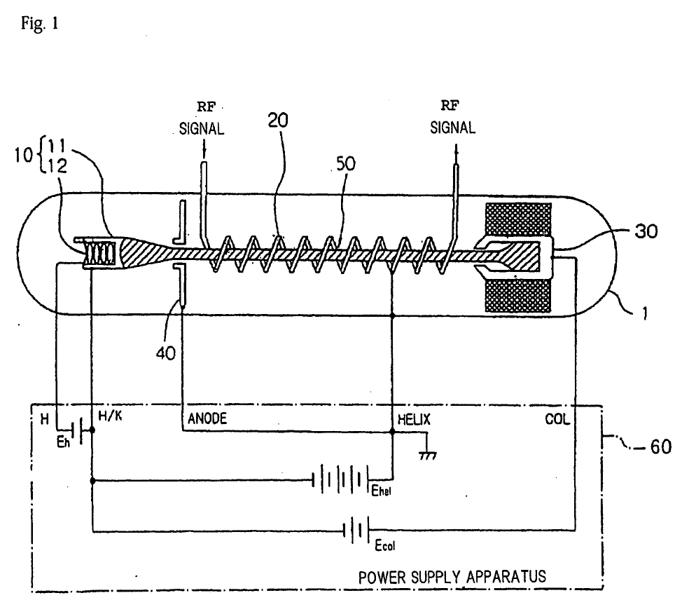

As shown in a diagonally shaded area of FIG. 4 and a wavy-line area of FIG. 5, molybdenum carbide layer 71 is formed so as to cover an area with which an electron emitted from a not-shown electron gun (see FIG. 1) strikes (area having a high probability of striking). More specifically, molybdenum carbide layer 71 is formed all over the inner surface of collector 70 that has a bottomed cylindrical shape and in the peripheral taper area of opening 72 on the outside surface of collector 70.

FIGS. 4 and 5 show an exemplary shape of collector 70 in the case of a TWT having only single collector. In the case of a TWT that has two or more collectors, the farthest collector from a helix (see FIG. 1), that is not shown, has a shape that is similar to the shape shown in FIGS. 4 and 5. Another collector is in a bottomless shape of collector 70 shown in FIGS. 4 and 5, as shown in FIG. 3.

Copper melts into a molybdenum material, that has the required porosity for impregnation, and that is formed into a plate or a bar, and porosity in the molybdenum material is filled with the copper, so that the molybdenum-copper composite material is formed. The ratio between the molybdenum and the copper (weight ratio) of the composite material is determined by the porosity of the molybdenum material. The porosity of the composite material is adjusted so that the weight ratio between the molybdenum and the copper (wt %) is a desired value.

The porosity of the molybdenum material can be controlled by a particle size of molybdenum powder, pressure at the time of forming, the sintering temperature, the sintering time, or the like in a step of forming the plate or the bar by press-molding and sintering the molybdenum powder.

Here, if a ratio of the copper in the composite material increases by increasing the porosity of the molybdenum material, bonding strength among molybdenum particles is reduced and thus the strength that is necessary for the collector is reduced. Also, the molybdenum that is made up of the material of molybdenum carbide layer 71 is reduced. Accordingly, it is preferable that the ratio of the copper to the molybdenum (weight ratio) be more than 0% and not more than 40% in the molybdenum-copper composite material of the exemplary embodiment.

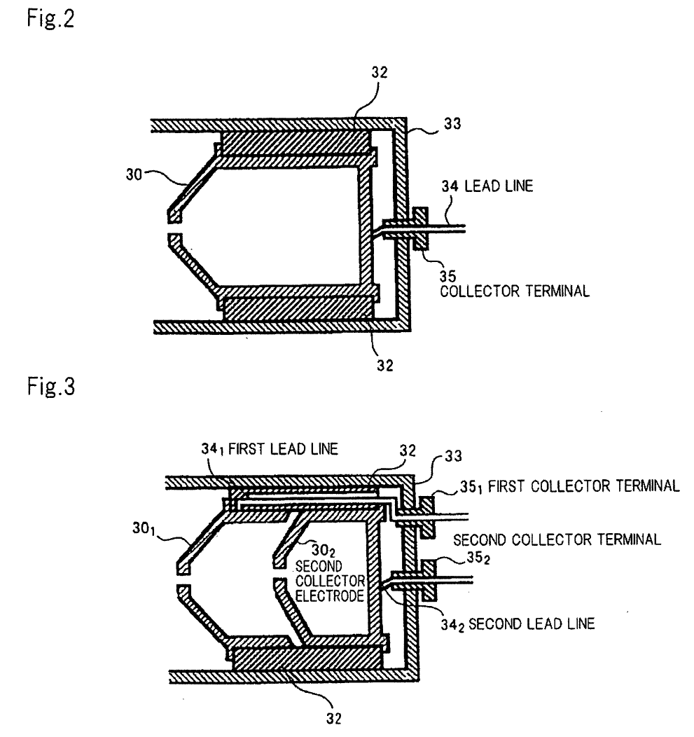

On the other hand, if the ratio of the copper in the composite material is reduced by reducing the porosity of the molybdenum material, the effect of improved thermal conductivity in the composite material, which is obtained by including copper, having high thermal conductivity, which will be described later, will be reduced. Additionally, it is preferable that the ratio between the molybdenum and the copper (weight ratio) in the molybdenum-copper composite material be set so that thermal expansion thereof is as much as the thermal expansion of member supporting collector 70 (insulating ceramic 32 shown in FIG. 2 or the like) made of the composite material. Accordingly, it is more preferable that the ratio of copper to molybdenum (weight ratio) be in a range of 15% to 25% in the molybdenum-copper composite material of the exemplary embodiment.

A carbon thin film is formed in a required area of a surface of collector 70 by, for example, a known sputtering method or CVD (Chemical Vapor Deposition) method, and then, the carbon thin film is alloyed with molybdenum under the thin film by heating it in a vacuum atmosphere, so that molybdenum carbide layer 71 is formed.

It may be considered possible that a melting point of the molybdenum-copper composite material is almost the same as that of molybdenum because molybdenum is not generally alloyed with copper. On the other hand, the thermal conductivity of the molybdenum-copper composite material is higher than that of molybdenum (on the order of 154 to 174 W/m·k) because of the presence of copper in porosity. Since molybdenum carbide layer 71 coated on the surface of collector 70 is a film, the thermal conductivity of collector 70 is hardly influenced.

Thus, forming collector 70 that is made of the molybdenum-copper composite material has better thermal conductivity than collector that is made of molybdenum. As a result, heat that is generated at collector 70 can be easily radiated, and it is more likely that the TWT will deliver high output power than in the case of collectors in the related art.

The melting point of the molybdenum-copper composite material is almost the same as that of molybdenum, and therefore, it is possible to make collector 70 comparatively thin. As a result, it is possible to downsize collector 70 and the TWT comprising thereof.

Additionally, since the value of a secondary electron emission coefficient δmax is small (δmax=0.90) in the molybdenum carbide, secondary electron emission generated at the time of electron collision at collector 70 is suppressed by forming molybdenum carbide layer 71 on the surface of collector 70. Because of this, a secondary electron emitted from collector 70 by the secondary electron emission becomes a return electron, and a helix current flowing to a ground potential through the helix (see FIG. 1) is reduced. Accordingly, efficiency of the traveling wave tube is improved and damage to the helix due to flowing of the helix current is suppressed.

Further, since the molybdenum material has a high hardness and includes porosity, it is difficult to machine and process the molybdenum material into the shape of collector 70. However, lubrication of the molybdenum-copper composite material is improved by the copper filled in porosity of the molybdenum material, and therefore, machinability is more improved than in the related art when a plate or a bar is processed into the shape of collector 70.

While an example is shown in which the molybdenum-copper composite material is used as collector 70 for the traveling wave tube in the above description, tungsten (W) can be used instead of molybdenum. In this case, a tungsten carbide layer may be formed in a similar manner to that described above in a required area of a collector surface made of a tungsten-copper composite material. For the reason similar to that of molybdenum-copper composite material, the ratio of copper to tungsten (weight ratio) in the tungsten-copper composite material may be set more than 0% and not more than 40%, and more preferably in the range of 15% to 25%.

Thermal conductivity of the tungsten-copper composite material is the same as that of the molybdenum-copper composite material and the melting point of tungsten is very high (3400° C.), similar to that of the molybdenum. Further, the value of a secondary electron emission coefficient δmax of tungsten carbide is 1 or less.

Accordingly, even though the collector is formed using tungsten-copper composite material, an effect that is similar to the case when molybdenum-copper composite material is used can be obtained.

While the invention has been particularly shown and described with reference to exemplary embodiments thereof, the invention is not limited to these exemplary embodiments. It will be understood by those ordinarily skilled in the art that various changes in form and details may be made therein without departing from the spirit and scope of the present invention as defined by the claims.

What is claimed is:

1. A collector of an electron tube, wherein said collector is made of a molybdenum-copper composite material.

2. The collector according to claim 1, wherein the ratio of copper to molybdenum is more than 0% and not more than 40% in the composite material.

3. The collector according to claim 2, wherein the ratio of copper to molybdenum is in a range of 15% to 25% in the composite material.

4. The collector according to claim 1, wherein a molybdenum carbide layer is formed close to a surface of a required area of the collector.

5. The collector according to claim 4, wherein the required area is an area with which an electron emitted from an electron gun of the electron tube collides.

6. A collector of an electron tube, wherein the collector is made of a tungsten-copper composite material.

7. The collector according to claim 6, wherein the ratio of copper to tungsten is more than 0% and not more than 40% in the composite material.

8. The collector according to claim 7, wherein the ratio of copper to tungsten is in a range of 15% to 25% in the composite material.

9. The collector according to claim 6, wherein a tungsten carbide layer is formed close to the surface of a required area of the collector.

10. The collector according to claim 9, wherein the required area is an area with which an electron emitted from an electron gun of the electron tube collides.

11. An electron tube comprising a collector according to claim 1.

12. An electron tube comprising a collector according to claim 6.
